(19) United States
(12) Patent Application Publication
(10) Pub. No.: US 2026/0088621 A1
(43) Pub. Date: Mar. 26, 2026

(54) IDLE POWER MANAGEMENT SYSTEM AND METHOD

(71) Applicant: LG ENERGY SOLUTION, LTD., Seoul (KR)

(72) Inventor: Yangsoo AN, Troy, MI (US)

(21) Appl. No.: 18/891,802

(22) Filed: Sep. 20, 2024

(51) Int. Cl. H02J 3/00; H02J 3/28; H02J 3/38; H02J 13/00

(52) U.S. Cl. CPC H02J 3/0075; H02J 3/004; H02J 3/28; H02J 3/38; H02J 13/13; H02J 2103/35

(57) ABSTRACT

An idle power management system and method are provided, wherein idle power that is available from an electrical power source can be transported to an electrical energy user in need of such power, via a transport entity having one or more transportable electrical energy storage devices.

### BACKGROUND

The energy generated at power generation facilities can be transmitted through a power distribution network, such as via transmission lines, to consumers in need of the generated power. While many power generation facilities still use fossil fuels, increasingly these facilities use eco-friendly energy generation and renewable energy generation processes, to provide for sustainable power generation.

However, a problem that can occur with such power generation facilities is that the generated power may not be fully utilized, and at least some portion of the generated energy may be lost, or the operation of a power generation facility may be suspended, if there is an imbalance between the amount of energy being generated and the consumer energy demand.

Certain energy management systems exist to control power supply and distribution according to pricing. For example, the Korea Power Exchange predicts electricity demand by time slot a day before the trading day and determines the market price by time slot by reflecting the generation bidding capacity and supply cost of each power generation facility. However, the forecasted power demand and the actual power demand can be quite different, and the power generation facility capacity can also vary on the trading day.

Accordingly, there remains a need for systems and methods to manage power generated by power generation facilities, such that demand by consumers for power is met, and without wasting of excess generated power.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Aspects of the present disclosure are directed to system having one or more processors, and one or more non-transitory computer-readable media storing computing instructions that, when executed on the one or more processors, cause the one or more processors to perform:
receiving, from an electrical power source, idle power availability information relating to current or predicted idle power availability at the electrical power source;
receiving, from an electrical energy user, (I) energy consumption information relating to current or predicted electrical energy consumption of the electrical energy user, and (ii) location information relating to a location of the electrical energy user;
receiving, from an entity having one or more transportable energy storage devices, idle power transport capability information relating to the ability of the one or more transportable energy storage devices to store idle power;
determining, based on the idle power availability information, whether the electrical power source meets a first criteria of currently having or being predicted to have, idle power available;
determining, based on the energy consumption information, whether the electrical energy user meets a second criteria of having a current or future need for electrical energy;
determining, based on the idle power transport capability information, whether the entity meets a third criteria of having at least one transportable energy storage device that is capable of storing and physically transporting idle power, and
in a case where it is determined that the first, second, and third criteria are met, providing instructions to one or more of the entity, the electrical energy user, and the electrical power source, to facilitate transfer of idle power from the electrical power source to the electrical energy user via:
transferring of idle power from the electrical power source to the at least one transportable energy storage device of the entity;
physically transporting the at least one transportable energy storage device having the idle power stored therein to the location of the electrical energy user, and
transferring the idle power stored in the at least one transportable energy storage device to the electrical energy user at the location.

Further aspects of the present disclosure are directed to a method implemented via execution of computing instructions configured to run at one or more processors, the method comprising:
receiving, from an electrical power source, idle power availability information relating to current or predicted idle power availability at the electrical power source;
receiving, from an electrical energy user, (a) energy consumption information relating to current or predicted electrical energy consumption of the electrical energy user, and (ii) location information relating to a location of the electrical energy user;
receiving, from an entity having one or more transportable energy storage devices, idle power transport capability information relating to the ability of the one or more transportable energy storage devices to store idle power;
determining, based on the idle power availability information, whether the electrical power source meets a first criteria of currently having or being predicted to have, idle power available;
determining, based on the energy consumption information, whether the electrical energy user meets a second criteria of having a current or future need for electrical energy,
determining, based on the idle power transport capability information, whether the entity meets a third criteria of having at least one transportable energy storage device that is capable of storing and physically transporting idle power, and
in a case where it is determined that the first, second, and third criteria are met, providing instructions to one or more of the entity, the electrical energy user, and the electrical power source, to facilitate transfer of idle power from the electrical power source to the electrical energy user via:
transferring of idle power from the electrical power source to the at least one transportable energy storage device of the entity;
physically transporting the at least one transportable energy storage device having the idle power stored therein to the location of the electrical energy user, and
transferring the idle power stored in the at least one transportable energy storage device to the electrical energy user at the location.

### BRIEF DESCRIPTION OF THE DRAWINGS

The accompanying drawings illustrate preferred embodiments of the present disclosure and together with the foregoing disclosure, serve to provide further understanding of the technical features of the present disclosure, and thus, the present disclosure is not construed as being limited to the drawings.

FIG. 1 is a diagram showing an embodiment of a network including an idle power management system, electrical power source, and electrical energy user, for transport of idle power.

FIG. 2 is a diagram showing another embodiment of a network including an idle power management system, electrical power source, and electrical energy user, for transport of idle power.

FIG. 3 is a block diagram of an embodiment of a computer system 100 for idle power management.

FIG. 4 illustrates a block diagram of a system 300 for idle power management.

FIGS. 5A-5B are a flow chart illustrating an embodiment of an idle power management method

FIG. 6 is a flow chart illustrating an embodiment of a method for matching an electrical power source, electrical energy user, and transport entity, for idle power management.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Accordingly, it is to be understood that the embodiments described herein and the configurations illustrated in the drawings are only the most preferred embodiments of the present disclosure and do not represent all of the technical ideas of the present disclosure, and that there may be various equivalents and variations that may be substituted for them at the time of filing the application.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

According to certain embodiments of the disclosure, a system and method are provided for managing idle power that is generated by an electrical power source, in order to provide for distribution and use of the energy so that it does not go to waste. By managing the idle power, according to certain aspects, the overall energy efficiency of the power source can be improved, by increasing the percentage of the overall energy generated by the power that is actually used. Aspects of the disclosure may also improve availability of power to energy users in real time, to enhance access to generated power that might otherwise go unused. According to certain aspects, the system is capable of identifying the source and/or location of idle power, determining an energy user to receive the idle power, and providing for coordination with an entity having transportable energy storage devices to facilitate physical transport of the idle power from the power source to the energy user in need of the energy.

According to certain embodiments, the transportable energy storage devices comprise batteries that are capable of receiving the idle power from a power source, such that it can be physically transported to the energy user. According to certain embodiments, the transportable energy storage devices can be tracked and monitored for safety as well as to determine a physical location and quantity of transportable energy storage devices available for energy transport in real time. By monitoring the status of the transportable energy storage devices, according to certain embodiments, transportable energy storage devices can be preemptively isolated and/or replaced if they are suspected of having safety issues or otherwise being defective.

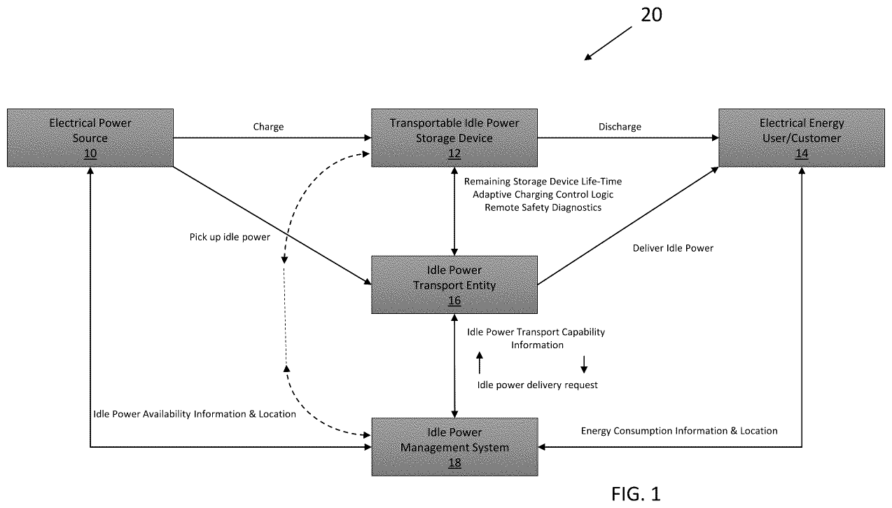

Referring to FIG. 1, a block diagram is provided that illustrates an embodiment of a system 20 for idle power management that forms a part of an idle power management and distribution network 18. As depicted in FIG. 1, the network 18 can comprise one or more electrical power sources 10 that are capable of providing electrical power, such as a power generator. The network 18 further comprises one or more electrical energy users and/or consumers 14. One or more idle power transport entities 16 are also provided as a part of the network 18, with the idle power transport entities 16 being capable of physically transporting idle power stored in one or more transportable idle power storage devices 12. An idle power management system 20 is in communication with, and is capable of receiving information from and/or providing information to, any one or more of the electrical power source(s) 10, the electrical energy user(s) 14, the one or more idle power transport entities 16, and even the one or more transportable idle power storage devices 12.

According to one embodiment, the electrical power source 10 comprises any one or more of an electrical power generation facility, an electrical charging station, and an electrical energy storage facility, as well as other entities that are capable of providing electrical power. The electrical power source 10 may be a large scale municipal or corporate facility, such as power generator that runs on fossil fuels, or that uses more sustainable power generation mechanisms such as solar, wind, or hydroelectric power, or other large-scale power generation. The electrical power 10 source may also be a small scale or individual power source, such as a personal electrical generator or personal solar power generator. According to certain embodiments, the electrical energy user 14 can comprise any selected from the group consisting of an individual electrical energy user, an industrial energy user, a vehicle, a home, a building, a local or municipal power grid, an electrical charging station, and an electrical energy storage facility, as well as other entities that consume energy. For example, in one embodiment, an electrical energy user 14 may be an electric vehicle driver in need a battery re-charge, such as from a charging station or other electric vehicle, but who does not have sufficient remaining battery charge to reach a charging station.

According to certain embodiments, the entity 16 having the one or more transportable energy storage devices 12 comprises any selected from the group consisting of an individual, an automobile, a company, a freight carrier, and an energy storage facility. That is, the entity 16 may be any that is capable of physically transporting energy storage devices 12 from one physical location to another, such that the energy storge devices can be supplied with idle power at one location, and delivered to a customer in need of the power at another location. For example, the entity 16 may be one that is capable of transporting one or more transportable energy storage devices 12, by loading the one or more devices onto a carrier comprising any selected from the group consisting of a car, truck, plane, ship and train.

According to certain embodiments, the transportable energy storage devices 12 can comprise batteries or other devices capable of storing power. According to certain embodiments, the transportable energy storage devices comprise secondary batteries that are capable of being repeatedly charged and discharges so as to provide for storage of electrical power from an electrical power source 10, and deliver to an electrical energy user 14. For example, according to certain embodiments, the one or more transportable energy storage devices can comprise one or more batteries that are capable of being physically transported by loading onto a carrier comprising any selected from the group consisting of a car, truck, plane, ship and train.

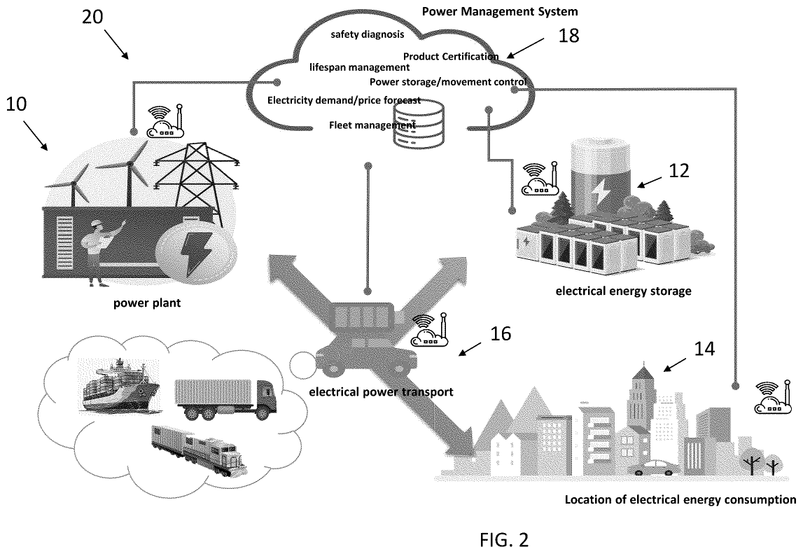

Referring to FIG. 2, an embodiment of the network 20 for idle power management and transport is shown, including a power plant as a power source 10, one or more batteries as the transportable idle power storage devices 12, an idle power transport entity 16 which is capable of transporting one or more storage devices by car or by other transportation or shipping methods, such as those shown, an electrical energy user 14 at a certain location, and an idle power management system 18 that receives information from and provide information to other members of the network 20. As depicted in FIG. 2, the idle power management system may be capable, in certain embodiments, of providing and receiving information related to idle power storage capacity, requirements, movement and control, as well as information related to fleet management involving the movement and physical transport of the storage devices, information related to electrical power demand and use, and the forecast for such demand and use, as well information regarding the storage devices and state thereof, such as information related to the lifespan of the storage devices, the safety and condition of the storage devices, and the certification of the storage devices for energy transport, among other metrics.

According to certain embodiments, the idle power management system 18 is capable of receiving information from and providing information to other members of the network 20, such as for example in order to manage idle power generated by a power source 10 to ensure it is provided to an electrical energy user 14 that has a need for the generated power.

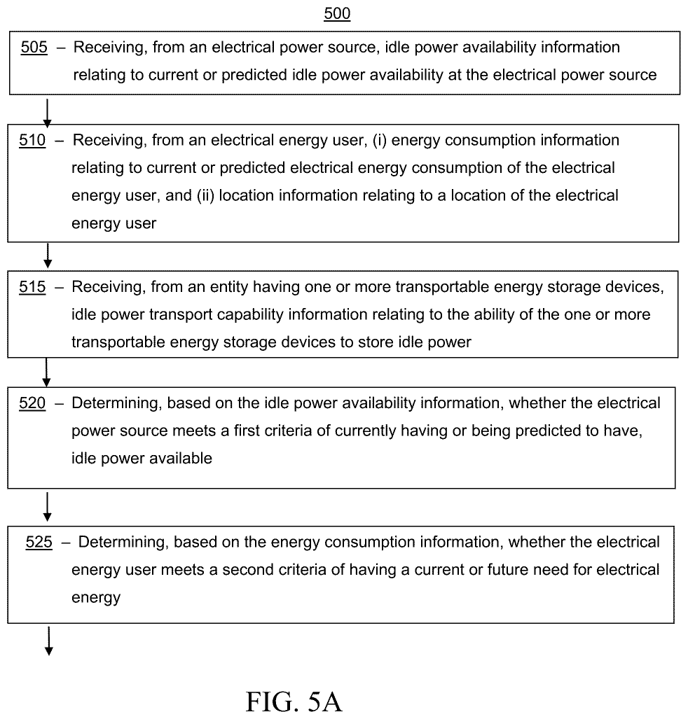

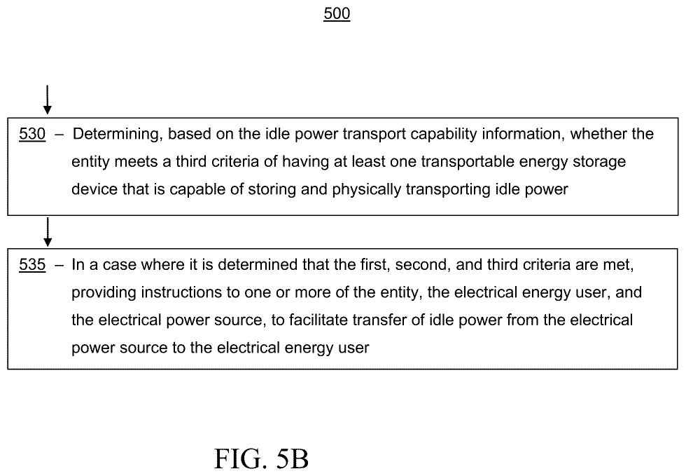

Turning ahead in the drawings, FIGS. 5A-5B illustrates a flow chart for a method 500 of managing idle power according to an embodiment of the disclosure. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, the system 18 is suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of system 18. The processor(s) can be similar or identical to the processor(s) described with respect to computer system 100 below.

In some embodiments, method 500 and other activities in method 500 can include using a distributed network including distributed memory architecture to perform the associated activity. This distributed architecture can reduce the impact on the network and system resources to reduce congestion in bottlenecks while still allowing data to be accessible from a central location.

As shown in FIG. 5A, in many embodiments, an activity 505 can involve receiving, from an electrical power source 10, idle power availability information relating to current or predicted idle power availability at the electrical power source. For example, the power source 10 may provide information relation to current power availability at the power source, or the predicted power availability at a future point in time, such as for example predicted based on expected power output in a future time frame, as well as the predicted demand for the power during that time frame. In many embodiments, an activity 510 can involve receiving, from an electrical energy user 14, (is) energy consumption information relating to current or predicted electrical energy consumption of the electrical energy user, and (ii) location information relating to a location of the electrical energy user. That is, the electrical energy user may be capable of providing information relating to their current electrical energy consumption and energy needs, and/or predicted electrical energy consumption and/or energy needs in a future time frame, such as in relation to an amount of electrical energy that is predicted to be required to perform certain operations and tasks, and the amount of electrical energy that is predicted to be available for the electrical energy user during that future time frame. For example, if the electrical energy user is a municipal power grid, they may be capable of estimating average electrical energy/power usage in a future time frame based on past usage, and also capable of estimating an amount of electrical power that may be available to the electrical energy user during that time period, to determine how much electrical energy in excess of may already be available will be needed from another source. Other estimates of current or predicted electrical energy consumption may also be generated by or for the electrical energy user, and provided to the system 18. The location information of the electrical energy user can be provided as information to the system 18 to facilitate the physical transfer and delivery of idle power to the electrical energy user at their physical location.

In many embodiments, an activity 515 can involve receiving, from an entity 16 having one or more transportable energy storage devices 12, idle power transport capability information relating to the ability of the one or more transportable energy storage devices to store idle power. For example, information about the available capacity of the entity for idle power transport, a number of storage devices 12 available for transport, a physical location of the one or more storage devices, and/or a location of one or more carriers (e.g. trucks, cars, ships, planes) for carrying the storage devices may be provided. As an example, logistical information regarding the location and route of one or more carriers may be provided. As another example, a number, energy capacity, location, and condition of one or more of the energy storage devices may be provided, such as for example an idle power storage capacity of the storage devices, a percent of the storage capacity that is available for use, and a physical location of the storage devices may be provided. As a further example, a condition and/or information about the lifespan of the energy storage device may be provided, such as for example information regarding the safety of the battery, and whether or not it is nearing the end of its useful lifespan or whether it may otherwise be suffering from a defect. According to the embodiment as shown in FIG. 1, the information regarding the status of the energy storage device, such as capacity and safety information, can be provided by the idle power transport entity 16 to the system 18, along with other information relating to the ability of the entity 16 to transport idle power (e.g. location and logistics information). According to yet another embodiment, as shown in the dotted line in FIG. 1, the transportable energy storage devices 12 may themselves provide information directly to the system 18, such as capacity, safety, lifespan, and location information.

In many embodiments, an activity 520 can involve determining, based on the idle power availability information, whether the electrical power source meets a first criteria of currently having or being predicted to have, idle power available. That is, the system 18 may determine whether the electrical power source 10 is one that either currently does have idle power available, or is expected to have idle power available in a future time frame. In many embodiments, an activity 525 can involve determining, based on the energy consumption information, whether the electrical energy user 14 meets a second criteria of having a current or future need for electrical energy. That is, the system 18 may determine whether the electrical energy user 14 is one that either currently is in need of electrical energy, or is expected to have a need for electrical energy in a future time frame. According to certain embodiments, the activities 520 and 525 can further involve determining whether the first and second criteria are met according to whether there is a match in terms of the time frame where excess idle power is expected to be available from the electrical power source, and is needed by the electrical energy user, such as for example where excess power will be available from the power source at the same time or shortly before electrical energy is expected to be needed by the electrical energy user. In a case where the network 20 includes multiple different electrical power sources 10 and/or multiple electrical energy users 14, the system 18 may be capable of determining whether there are multiple matches where the first and second criteria are met, from among the multiple electric power sources 10 and the multiple electrical energy users 14. For example, the system 18 may be capable of determining whether there are any power sources 10 that are capable of meeting the electrical energy consumption needs of one or more electrical energy users, and/or whether there are any electrical energy users that could benefit from idle power generated by one or more electrical power sources.

Referring to FIG. 5B, in many embodiments, an activity 530 can involve determining, based on the idle power transport capability information, whether the entity 16 meets a third criteria of having at least one transportable energy storage device that is capable of storing and physically transporting idle power. For example, the system 18 may be capable of determining whether the entity has sufficient storage devices/idle power storage capacity available, and/or whether the carriers used by the entity are in a geographic location suited for transport from the electrical power source 10 to the electrical energy user 14, among other parameters. As another example, the system 18 may be capable of determining whether the third criteria is met by determining whether the entity 16 has resources that are suitable for the transport of idle power between an electrical power source 10 and an electrical energy user 14 that are matched based on the first and second criteria, such as for example a capacity that is sufficient to store the idle power intended for transport from the electrical power source 10 to the electrical energy user 14, and a location of carriers that is sufficiently close or convenient for transport of idle power between the location of the electrical power source and the location of the electrical energy user.

In many embodiments, an activity 535 can involve, in a case where it is determined that the first, second, and third criteria are met, providing instructions to one or more of the entity 16, the electrical energy user 14, and the electrical power source 10, to facilitate transfer of idle power from the electrical power source to the electrical energy user. According to certain embodiments, the transfer of idle power from the electrical power source 10 to the electrical energy user 4 occurs via transfer of idle power from the electrical power source to at least one transportable energy storage device 12 of the entity 16. For example, one or more energy storage devices 12 may be physically transported to the location of the electrical power source 10, such as by using one or more carriers of the entity, in order to charge the storage devices with the idle power from the electrical power source. According to certain embodiments, the transfer can further comprise physically transporting the at least one transportable energy storage device having the idle power stored therein, to the location of the electrical energy user. For example, the one or more energy storage devices 12 having the idle power stored therein may be physically transported to the location electrical energy user, such as by using one or more carriers of the entity, to provide the idle power to the electrical energy user. According to certain embodiments, the transfer can further comprise transferring the idle power stored in the at least one transportable energy storage device to the electrical energy user at the location, such as for example by discharging the one or more transportable energy storage devices having the idle power stored therein to an energy storage device of the user, or otherwise providing for transfer of the idle power to the electrical energy user. For example, in the case of the electric vehicle owner that is in need of electrical charge described above, the method may be capable of matching the electrical vehicle owner with an electrical power source, such as a charging station, and a transport entity, to transport the needed power from the charging station or other power source to the electric vehicle that is in need of power.

According to certain embodiments, the transfer of idle power stored in the energy storage device to the user comprises all of the stored idle power, and in other embodiments, just some fraction of the idle power suited to meet the user's consumption needs are transferred, and a remaining idle power amount is reserved for transport to another user. According to certain further embodiments, the transfer of idle power can comprise the use of multiple different energy storage devices, and/or multiple different carriers. The transferred idle power may also come from only a single electrical power source, or multiple electrical power sources, such as when idle power from a plurality of electrical power sources is necessary to meet the consumption needs of one or more users. The transferred idle power may also be transferred to just a single electrical power user at a single location, or to a plurality of electrical power users at a same location or different locations.

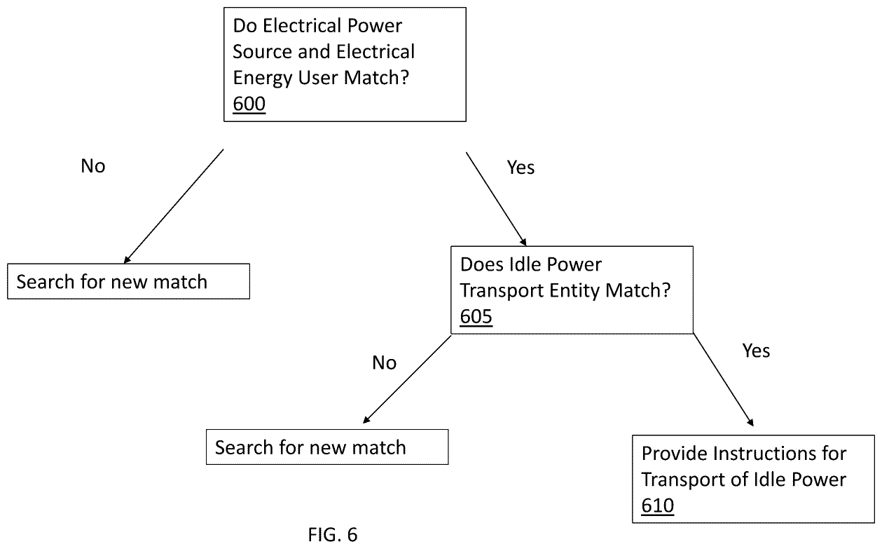

According to one embodiment of the method 500 where a plurality of electrical energy sources and a plurality of electrical energy users are a part of the network 20, the activity 505 can include receiving, from the plurality of electrical power sources, idle power availability information relating to current or predicted idle power availability at each of the plurality of electrical power sources. The activity 510 can include receiving, from the plurality of electrical energy users, energy consumption information relating to current or predicted electrical energy consumption of each of the plurality of electrical energy users. The activity 520 can include determining, based on the idle power availability information, whether any of the plurality of electrical power sources meets the first criteria of currently having or being predicted to have, idle power available. The activity 525 can include determining, based on the energy consumption information, whether any of the plurality of electrical energy users meets the second criteria of having the current or future need for electrical energy. The method can further comprise activity 605, as shown in FIG. 6 of matching one or more of the electrical power sources that meet the first criteria in the plurality of electrical power sources, with one or more electrical energy users that meet the second criteria in the plurality of electrical energy users. If there is no match between a given electrical power source and a given electrical energy user, then the system 18 can search for another match. If there is a match, then the method can further comprise in activity 535 providing instructions to one or more of the entity, the one or more electrical power sources that meet the first criteria, and the one or more electrical energy users that meet the second criteria, to facilitate transfer of idle power from the one or more electrical power sources to the one or more electrical energy users that are matched with one another (i.e. via the transport entity).

According to one embodiment of the method 500 where a plurality of entities having a plurality of energy storage devices are a part of the network 20, the activity 515 can comprise receiving, from the plurality of entities having one or more transportable energy storage devices, idle power transport capability information relating to the ability of the one or more transportable energy storage devices of each entity of the plurality of entities, to store idle power. The activity 530 can comprise determining, based on the idle power transport capability information, whether any of the plurality of entities meets the third criteria of having at least one transportable energy storage device that is capable of storing and physically transporting idle power. The method can further comprise activity 610, as shown in FIG. 6 of matching one or more of the entities that meet the third criteria in the plurality of entities, with one or more electrical power sources that meet the first criteria in the plurality of electrical power sources, and with one or more electrical energy users that meet the second criteria in the plurality of electrical energy users. If there is no match between a given transport entity with the electrical power source(s) and the electrical energy user(s), then the system 18 can search for another match. If there is a match, then the method can further comprise in activity 535 providing instructions to the one or more electrical power sources that meet the first criteria, the one or more electrical energy users that meet the second criteria, and the one or more entities that meet the third criteria, to facilitate transfer of idle power from the one or more electrical power sources to the one or more electrical energy users via the at least one transportable energy storage device of the one or more entities that are matched with one another.

According to one embodiment, matching of the one or more of the electrical power sources that meet the first criteria in the plurality of electrical power sources, with one or more electrical energy users that meet the second criteria in the plurality of electrical energy users, and matching of the one or more entities that meet the third criteria in the plurality of entities, with the one or more electrical power sources that meet the first criteria in the plurality of electrical power sources, and the one or more electrical energy users that meet the second criteria in the plurality of electrical energy users, comprises matching based on any of several parameters. According one embodiment, the parameters used to determine whether there is a match between the electrical power source(s), electrical energy user(s) and transport entity/entities can include a proximity of the one or more electrical power sources that meet the first criteria to the one or more electrical energy users that meet the second criteria. For example, if the electrical power source(s) and electrical energy user(s) are too far away from each other geographically, then they may not be deemed a match, even if other parameters such as the amount of idle power available and the amount needed are otherwise a good match. Conversely, if the electrical power source(s) and electrical energy user(s) are in relatively close proximity to each other, then they may be a good match.

Other parameters that may be used to determine the match, according to certain embodiments, are whether an amount of electrical energy required by the one or more electrical energy users meets the second criteria, and/or whether an amount of electrical energy available from the one or more electrical power sources meets the first criteria. If the amount of electrical power needed and the amount available correspond, then the electrical power source(s) and electrical energy user(s) may be matched. If not, then a further electrical power source may be sought, either to supplement or as an alternative, if the amount available is not adequate, and further electrical energy users may be sought if the amount of idle power exceeds that needed by a given electrical energy user.

According to certain embodiments, a compatibility between the one or more electrical power sources that meet the first criteria and the one or more electrical energy users that meet the second criteria may be a parameter used to determine whether there is a match. For example, if the electrical energy user is not able to use energy provided in a format delivered by the electrical power source, then there may not be a match between the power source and the electrical energy user.

According to certain embodiments, a parameter used to determine a match with the transport entity can include an availability of carriers for the one or more transportable energy storage devices, as well as proximity of the one or more entities that meet the third criteria to the one or more electrical power sources that meet the first criteria, and/or a proximity of the one or more entities that meet the third criteria to the one or more electrical energy users that meet the second criteria. That is, if the transport entity has available carriers that are in proximity to the electrical power source and electrical energy user, then in certain embodiments a match may be made. If the transport entity does not have carriers that are in proximity, then a match with a different transport entity may be sought. According to certain embodiments, a parameter used to determine a match may be an amount of idle energy capable of being stored by the at least one transportable energy storage device of the one or more entities that meet the third criteria. For example, if the one or more transportable energy storage device of the transport entity cannot accommodate the amount of idle power that is intended to be transfer, then a match with a different transport entity may be sought. Relatedly, other parameters that may be used to determine a match may be a compatibility between the one or more electrical power sources that meet the first criteria and the one or more entities that meet the third criteria, and compatibility between the one or more electrical energy users that meet the second criteria and the one or more entities that meet the third criteria. For example, if the transport entity provides energy storage devices that are not capable of receiving idle power in a format provided by the electrical power source, or delivering power in a format suitable for the electrical energy user, then a match with a different transport entity may be sought.

According to certain embodiments, a parameter used to determine a match with the transport entity may depend on safety and/or status information from the energy storage devices of the transport entity. For example, diagnostic information of the transportable energy storage devices may be provided either directly to the system 18 from the energy storage devices, or indirectly to the system from the transport entity in a case where the transport entity is solely monitoring the energy storage devices. The safety and/or status information may be information transmitted by a battery monitoring system or similar system capable of diagnosing the device for defect, and obtaining other lifespan and capacity information about the energy storage device. For example, the safety and/or status information may include information about whether the energy storage device is functioning properly, or whether a dangerous condition with the battery exists, or whether it is nearing the end of its useful lifetime due to decreased capacity or other features. The status information may also include information such as a current state of charge of the battery, and an overall capacity of the battery to receive and store the idle power, as well as charge and discharge protocols and compatibility considerations. According to yet a further embodiment, the system 18 may be capable of monitoring the energy storage device(s), either directly or indirectly via information received from the transport entity, during any one or more of pickup of the idle power from the electrical power source, transport of the idle power, and delivery of the idle power to the electrical energy user, to continuously assess the status and safety of the energy storage device. For example, the system 18 may request a cease in any of pickup, transport, and delivery of the idle power if a defect in the energy storage device is detected at some part of the idle power transport process. According to another example, the system 18 may seek a match with a different transport entity if a defect is detected during the idle power transport process. According to yet another embodiment, the system 18 may seek a match with a transport entity that has at least one transportable energy storage device that comprises a safety device to reduce a fire risk posed by the transportable energy storage device.

Returning to FIGS. 5A-5B, according to one embodiment of the method 500, the activity 535 of providing instructions to facilitate the transport of the idle power from the electrical power source to the electrical energy user comprises receiving a location of the electrical power source that meets the first criteria, receiving a quantity of idle power needed by the electrical energy user that meets the second criteria, instructing the entity that meets the third criteria to transport the at least one transportable energy storage device to the location of the electrical power source that meets the first criteria, instructing the electrical power source that meets the first criteria to transfer the quantity of idle power needed by the electrical energy user to the at least one transportable energy storage device, instructing the entity that meets the third criteria to transport the at least one transportable energy storage device having the idle power stored therein to the location of the electrical energy user that meets the second criteria, and instructing the electrical energy user that meets the second criteria to transfer the idle power from the transportable energy storage device.

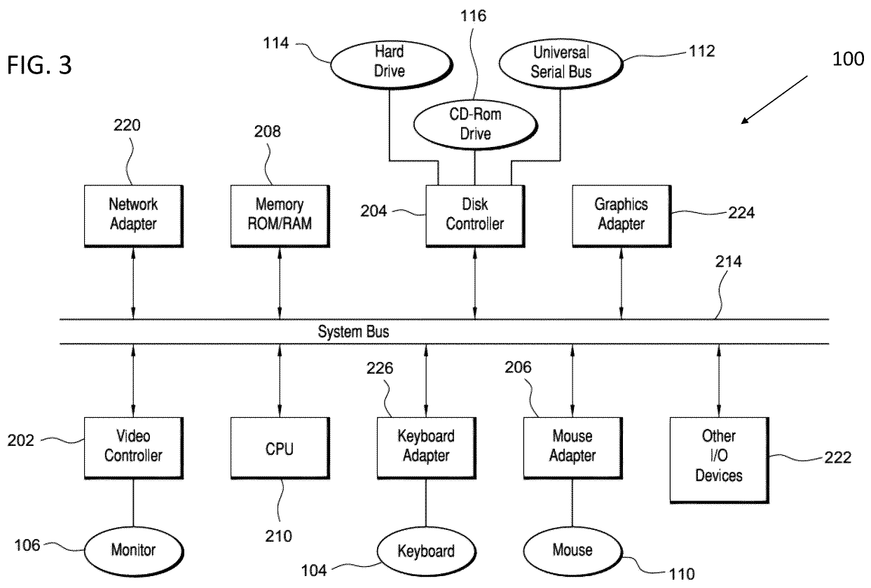

Referring to FIG. 3, an exemplary block diagram of an embodiment of a computer system 100 is illustrated, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise a chassis containing one or more circuit boards (not shown), a Universal Serial Bus (USB) port 112, a Compact Disc Read-Only Memory (CD-ROM) and/or Digital Video Disc (DVD) drive 116, and a hard drive 114. A central processing unit (CPU) 210 is coupled to a system bus 214 in FIG. 3. In various embodiments, the architecture of CPU 210 can be compliant with any of a variety of commercially distributed architecture families.

Continuing with FIG. 3, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112, hard drive 114, and/or CD-ROM, DVD, Blu-Ray, or other suitable media, such as media configured to be used in CD-ROM and/or DVD drive 116. Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 3, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard and a mouse, respectively, of the computer system 100. While graphics adapter 224 and video controller 202 are indicated as distinct units in FIG. 3, video controller 202 can be integrated into graphics adapter 224, or vice versa in other embodiments. Video controller 202 is suitable for refreshing a monitor 106 to display images on a screen 108 of computer system 100. Disk controller 204 can control hard drive 114, USB port 112, and CD-ROM and/or DVD drive 116. In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100. In other embodiments, the WNIC card can be a wireless network card built into computer system 100. A wireless network adapter can be built into computer system 100 by having wireless communication capabilities integrated into the motherboard chipset (not shown), or implemented via one or more dedicated wireless communication chips (not shown), connected through a PCI (peripheral component interconnector) or a PCI express bus of computer system 100 or USB port 112. In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis are not discussed herein.

When computer system 100 in FIG. 3 is running, program instructions stored on a USB drive in USB port 112, on a CD-ROM or DVD in CD-ROM and/or DVD drive 116, on hard drive 114, or in memory storage unit 208 are executed by CPU 210. A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 may in certain embodiments be a desktop or a laptop computer, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

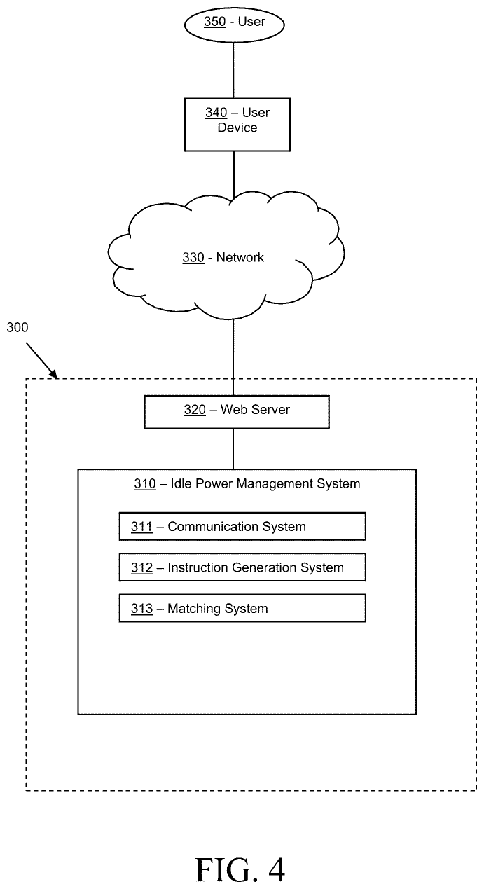

FIG. 4 illustrates a block diagram of a system 300 that can be employed for idle power management, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include idle power management system 310 (e.g. corresponding to idle power management system 18 in FIGS. 1 and 2) and/or a web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Idle power management system 310 and/or web server 320 can each be a computer system, such as computer system 100, as described above, and can each be a single computer, a single server, or a cluster or collection of computers or servers, or a cloud of computers or servers. In another embodiment, a single computer system can host the idle power management system 310 and/or web server 320. Additional details regarding idle power management system 310 and/or web server 320 are described herein.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to manage idle power, such as by searching for available electrical energy power sources having idle power and/or electrical energy users in need of power, as well as transport entities capable of physically transporting idle power, in addition to other suitable activities, or to interface with and/or configure the idle power management system 310.

In some embodiments, an internal network that is not open to the public can be used for communications between the idle power management system 310 and web server 320 within system 300. Accordingly, in some embodiments, idle power management system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300. In certain embodiments, the user devices (e.g., user device 340) can be desktop computers, laptop computers, mobile devices, and/or other endpoint devices used by one or more users (e.g., user 350).

In many embodiments the idle power management system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.).

Meanwhile, in many embodiments, idle power management system 310 and/or web server 320 also can be configured to communicate with one or more databases. The one or more databases can include databases that contains information about electrical power sources, electrical energy users, and transport entities. The one or more databases can be stored on one or more memory storage units (e.g., non-transitory computer readable media), which can be similar or identical to the one or more memory storage units (e.g., non-transitory computer readable media) described above with respect to computer system 100. Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

Meanwhile, idle power management system 310, web server 320, and/or the one or more databases can be implemented using any suitable manner of wired and/or wireless communication. Accordingly, system 300 can include any software and/or hardware components configured to implement the wired and/or wireless communication.

In many embodiments, idle power management system 310 can include a communication system 311, an instruction generation system 312, and a matching system 33. In many embodiments, the systems of idle power management system 310 can be modules of computing instructions (e.g., software modules) stored at non-transitory computer readable media that operate on one or more processors. In other embodiments, the systems of idle power management system 310 can be implemented in hardware. Idle power management system 310 and/or web server 320 each can be a computer system, such as computer system 100, as described above, and can be a single computer, a single server, or a cluster or collection of computers or servers, or a cloud of computers or servers. In another embodiment, a single computer system can idle power management system 310 and/or web server 320.

In many embodiments, system 300 (FIG. 4), idle power management system 310, and/or web server 320 can be suitable to perform method 500 and/or one or more of the activities of method 500 (including the matching activities depicted in FIG. 6). In these or other embodiments, one or more of the activities of method 500 can be implemented as one or more computing instructions configured to run at one or more processors and configured to be stored at one or more non-transitory computer readable media. Such non-transitory computer readable media can be part of system 300. The processor(s) can be similar or identical to the processor(s) described above with respect to computer system 100. As an example, according to certain embodiments, the activities 505, 510 and 515 may be performed by the communication system 311, by receiving communications and information from the electrical power source, electrical energy user, and transport entity. As another example, according to certain embodiments, the activities 520, 525 and 530, as well as activities 600 and 605 in FIG. 6 may be performed by matching system 313, such as for example by determining whether first, second and third criteria are met, and whether there is a match between any of the electrical power source, electrical energy user, and transport entity. As another example, according to certain embodiments, the activity 535 in FIG. 5 and the activity 610 in FIG. 6 may be performed by the instruction generation system 312. Other embodiments and configurations of the system 300 including the idle power management system 3120 and web server 320 can also be provided.

In many embodiments, the techniques described herein can provide a practical application and several technological improvements. In some embodiments, the techniques described herein can provide for the efficient and accurate management of idle power, such that excess power generated or stored by an electrical power source does not go wasted, and so that electrical energy users do not lack for needed power. The methods and systems provided herein further provide significant improvements over prior methods, which do not provide for identifying and matching transport entities to provide real-time transport and distribution of idle power on an as-needed basis. Embodiments of the disclosure also provide for the ability to sell and re-sale power on an on-demand basis, but identifying available idle power and possible recipients for such idle power in real-time. Embodiments of the disclosure also facilitate power transport without to areas that may not be able to reliably receive electrical power through a grid, or who are not connected to an electrical grid, or in the event of electrical grid failure or other issue. Also, embodiments of the disclosure may allow for real-time monitoring of the energy storage devices being used for idle power transport, which can enhance the safety of the idle power transport, and also allow for pre-emptive isolation or replacement of energy storage devices that are identified as being defective. Yet a further feature of embodiments of the disclosure provided herein are that electrical power can be circulated to areas where it is needed, rather than going unused or even wasted.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
one or more processors; and
one or more non-transitory computer-readable media storing computing instructions that, when executed on the one or more processors, cause the one or more processors to perform:
receiving, from an electrical power source, idle power availability information relating to current or predicted idle power availability at the electrical power source;
receiving, from an electrical energy user, (I) energy consumption information relating to current or predicted electrical energy consumption of the electrical energy user, and (ii) location information relating to a location of the electrical energy user;
receiving, from an entity having one or more transportable energy storage devices, idle power transport capability information relating to the ability of the one or more transportable energy storage devices to store idle power;
determining, based on the idle power availability information, whether the electrical power source meets a first criteria of currently having or being predicted to have, idle power available;
determining, based on the energy consumption information, whether the electrical energy user meets a second criteria of having a current or future need for electrical energy;
determining, based on the idle power transport capability information, whether the entity meets a third criteria of having at least one transportable energy storage device that is capable of storing and physically transporting idle power, and
in a case where it is determined that the first, second, and third criteria are met, providing instructions to one or more of the entity, the electrical energy user, and the electrical power source, to facilitate transfer of idle power from the electrical power source to the electrical energy user via:
transferring of idle power from the electrical power source to the at least one transportable energy storage device of the entity;
physically transporting the at least one transportable energy storage device having the idle power stored therein to the location of the electrical energy user, and
transferring the idle power stored in the at least one transportable energy storage device to the electrical energy user at the location.

2. The system of claim 1, wherein the electrical power source comprises any one or more of an electrical power generation facility, an electrical charging station, and an electrical energy storage facility.

3. The system of claim 1, wherein the electrical energy user comprises any selected from the group consisting of an individual electrical energy user, an industrial energy user, a vehicle, a home, a building, a local or municipal power grid, an electrical charging station, and an electrical energy storage facility.

4. The system of claim 1, wherein the entity having the one or more transportable energy storage devices comprises any selected from the group consisting of an individual, an automobile, a company, a freight carrier, and an energy storage facility.

5. The system of claim 1, wherein the one or more transportable energy storage devices comprise one or more batteries capable of being physically transported by loading onto a carrier comprising any selected from the group consisting of a car, truck, plane, ship and train.

6. The system of claim 1, wherein the computing instructions, when executed on the one or more processors, cause the one or more processors to perform:
receiving, from a plurality of electrical power sources, idle power availability information relating to current or predicted idle power availability at each of the plurality of electrical power sources;
receiving, from a plurality of electrical energy users, energy consumption information relating to current or predicted electrical energy consumption of each of the plurality of electrical energy users;
determining, based on the idle power availability information, whether any of the plurality of electrical power sources meets the first criteria of currently having or being predicted to have, idle power available;
determining, based on the energy consumption information, whether any of the plurality of electrical energy users meets the second criteria of having the current or future need for electrical energy; and
matching one or more of the electrical power sources that meet the first criteria in the plurality of electrical power sources, with one or more electrical energy users that meet the second criteria in the plurality of electrical energy users, and
providing instructions to one or more of the entity, the one or more electrical power sources that meet the first criteria, and the one or more electrical energy users that meet the second criteria, to facilitate transfer of idle power from the one or more electrical power sources to the one or more electrical energy users that are matched with one another.

7. The system of claim 6, wherein the computing instructions, when executed on the one or more processors, cause the one or more processors to perform:
receiving, from a plurality of entities having one or more transportable energy storage devices, idle power transport capability information relating to the ability of the one or more transportable energy storage devices of each entity of the plurality of entities, to store idle power;
determining, based on the idle power transport capability information, whether any of the plurality of entities meets the third criteria of having at least one transportable energy storage device that is capable of storing and physically transporting idle power,
matching one or more of the entities that meet the third criteria in the plurality of entities, with one or more electrical power sources that meet the first criteria in the plurality of electrical power sources, and with one or more electrical energy users that meet the second criteria in the plurality of electrical energy users, and
providing instructions to the one or more electrical power sources that meet the first criteria, the one or more electrical energy users that meet the second criteria, and the one or more entities that meet the third criteria, to facilitate transfer of idle power from the one or more electrical power sources to the one or more electrical energy users via the at least one transportable energy storage device of the one or more entities that are matched with one another.

8. The system of claim 7, wherein matching of the one or more of the electrical power sources that meet the first criteria in the plurality of electrical power sources, with one or more electrical energy users that meet the second criteria in the plurality of electrical energy users, and matching of the one or more entities that meet the third criteria in the plurality of entities, with the one or more electrical power sources that meet the first criteria in the plurality of electrical power sources, and the one or more electrical energy users that meet the second criteria in the plurality of electrical energy users, comprises matching based on any of:
a proximity of the one or more electrical power sources that meet the first criteria to the one or more electrical energy users that meet the second criteria;
an amount of electrical energy required by the one or more electrical energy users that meet the second criteria;
an amount of electrical energy available from the one or more electrical power sources that meet the first criteria;
a compatibility between the one or more electrical power sources that meet the first criteria and the one or more electrical energy users that meet the second criteria;
an availability of carriers for the one or more transportable energy storage devices. a proximity of the one or more entities that meet the third criteria to the one or more electrical power sources that meet the first criteria;
a proximity of the one or more entities that meet the third criteria to the one or more electrical energy users that meet the second criteria;
an amount of idle energy capable of being stored by the at least one transportable energy storage device of the one or more entities that meet the third criteria;
a compatibility between the one or more electrical power sources that meet the first criteria and the one or more entities that meet the third criteria,
a compatibility between the one or more electrical energy users that meet the second criteria and the one or more entities that meet the third criteria, and
a safety and/or lifespan diagnosis of the one or more transportable energy storage devices.

9. The system of claim 1, wherein the computing instructions, when executed on the one or more processors, cause the one or more processors to perform:
receiving a location of the electrical power source that meets the first criteria;
receiving a quantity of idle power needed by the electrical energy user that meets the second criteria;
instructing the entity that meets the third criteria to transport the at least one transportable energy storage device to the location of the electrical power source that meets the first criteria;
instructing the electrical power source that meets the first criteria to transfer the quantity of idle power needed by the electrical energy user to the at least one transportable energy storage device;
instructing the entity that meets the third criteria to transport the at least one transportable energy storage device having the idle power stored therein to the location of the electrical energy user that meets the second criteria, and
instructing the electrical energy user that meets the second criteria to transfer the idle power from the transportable energy storage device.

10. The system of claim 1, wherein the at least one transportable energy storage device comprises a safety device to reduce a fire risk posed by the at least one transportable energy storage device.

11. A method implemented via execution of computing instructions configured to run at one or more processors, the method comprising:
receiving, from an electrical power source, idle power availability information relating to current or predicted idle power availability at the electrical power source;
receiving, from an electrical energy user, (i) energy consumption information relating to current or predicted electrical energy consumption of the electrical energy user, and (ii) location information relating to a location of the electrical energy user;
receiving, from an entity having one or more transportable energy storage devices, idle power transport capability information relating to the ability of the one or more transportable energy storage devices to store idle power;
determining, based on the idle power availability information, whether the electrical power source meets a first criteria of currently having or being predicted to have, idle power available;
determining, based on the energy consumption information, whether the electrical energy user meets a second criteria of having a current or future need for electrical energy,
determining, based on the idle power transport capability information, whether the entity meets a third criteria of having at least one transportable energy storage device that is capable of storing and physically transporting idle power, and
in a case where it is determined that the first, second, and third criteria are met, providing instructions to one or more of the entity, the electrical energy user, and the electrical power source, to facilitate transfer of idle power from the electrical power source to the electrical energy user via:
transferring of idle power from the electrical power source to the at least one transportable energy storage device of the entity;
physically transporting the at least one transportable energy storage device having the idle power stored therein to the location of the electrical energy user, and
transferring the idle power stored in the at least one transportable energy storage device to the electrical energy user at the location.

12. The method of claim 11, wherein the electrical power source comprises any one or more of an electrical power generation facility, an electrical charging station, and an electrical energy storage facility.

13. The method of claim 11, wherein the electrical energy user comprises any selected from the group consisting of an individual electrical energy user, an industrial energy user, a vehicle, a home, a building, a local or municipal power grid, an electrical charging station, and an electrical energy storage facility.

14. The method of claim 11, wherein the entity having the one or more transportable energy storage devices comprises any selected from the group consisting of an individual, an automobile, a company, a freight carrier, and an energy storage facility.

15. The method of claim 11, wherein the one or more transportable energy storage devices comprise one or more batteries capable of being physically transported by loading onto a carrier comprising any selected from the group consisting of a car, truck, plane, ship and train.

16. The method of claim 11, further comprising:
receiving, from a plurality of electrical power sources, idle power availability information relating to current or predicted idle power availability at each of the plurality of electrical power sources;
receiving, from a plurality of electrical energy users, energy consumption information relating to current or predicted electrical energy consumption of each of the plurality of electrical energy users;
determining, based on the idle power availability information, whether any of the plurality of electrical power sources meets the first criteria of currently having or being predicted to have, idle power available;
determining, based on the energy consumption information, whether any of the plurality of electrical energy users meets the second criteria of having the current or future need for electrical energy; and
matching one or more of the electrical power sources that meet the first criteria in the plurality of electrical power sources, with one or more electrical energy users that meet the second criteria in the plurality of electrical energy users, and
providing instructions to one or more of the entity, the one or more electrical power sources that meet the first criteria, and the one or more electrical energy users that meet the second criteria, to facilitate transfer of idle power from the one or more electrical power sources to the one or more electrical energy users that are matched with one another.

17. The method of claim 16, further comprising:
receiving, from a plurality of entities having one or more transportable energy storage devices, idle power transport capability information relating to the ability of the one or more transportable energy storage devices of each entity of the plurality of entities, to store idle power;
determining, based on the idle power transport capability information, whether any of the plurality of entities meets the third criteria of having at least one transportable energy storage device that is capable of storing and physically transporting idle power,
matching one or more of the entities that meet the third criteria in the plurality of entities, with one or more electrical power sources that meet the first criteria in the plurality of electrical power sources, and with one or more electrical energy users that meet the second criteria in the plurality of electrical energy users, and
providing instructions to the one or more electrical power sources that meet the first criteria, the one or more electrical energy users that meet the second criteria, and the one or more entities that meet the third criteria, to facilitate transfer of idle power from the one or more electrical power sources to the one or more electrical energy users via the at least one transportable energy storage device of the one or more entities that are matched with one another.

18. The method of claim 17, wherein matching of the one or more of the electrical power sources that meet the first criteria in the plurality of electrical power sources, with one or more electrical energy users that meet the second criteria in the plurality of electrical energy users, and matching of the one or more entities that meet the third criteria in the plurality of entities, with the one or more electrical power sources that meet the first criteria in the plurality of electrical power sources, and the one or more electrical energy users that meet the second criteria in the plurality of electrical energy users, comprises matching based on any of:
a proximity of the one or more electrical power sources that meet the first criteria to the one or more electrical energy users that meet the second criteria;
an amount of electrical energy required by the one or more electrical energy users that meet the second criteria;
an amount of electrical energy available from the one or more electrical power sources that meet the first criteria;
a compatibility between the one or more electrical power sources that meet the first criteria and the one or more electrical energy users that meet the second criteria, and
an availability of carriers for the one or more transportable energy storage devices. a proximity of the one or more entities that meet the third criteria to the one or more electrical power sources that meet the first criteria;
a proximity of the one or more entities that meet the third criteria to the one or more electrical energy users that meet the second criteria;
an amount of idle energy capable of being stored by the at least one transportable energy storage device of the one or more entities that meet the third criteria;
a compatibility between the one or more electrical power sources that meet the first criteria and the one or more entities that meet the third criteria, and
a compatibility between the one or more electrical energy users that meet the second criteria and the one or more entities that meet the third criteria.

19. The method of claim 11, further comprising:
receiving a location of the electrical power source that meets the first criteria;
receiving a quantity of idle power needed by the electrical energy user that meets the second criteria;
instructing the entity that meets the third criteria to transport the at least one transportable energy storage device to the location of the electrical power source that meets the first criteria;
instructing the electrical power source that meets the first criteria to transfer the quantity of idle power needed by the electrical energy user to the at least one transportable energy storage device;
instructing the entity that meets the third criteria to transport the at least one transportable energy storage device having the idle power stored therein to the location of the electrical energy user that meets the second criteria, and
instructing the electrical energy user that meets the second criteria to transfer the idle power from the transportable energy storage device.

20. The method of claim 11, wherein the at least one transportable energy storage device comprises a safety device to reduce a fire risk posed by the at least one transportable energy storage device.
